(19) United States
(12) Patent Application Publication
(10) Pub. No.: US 2023/0107560 A1
(43) Pub. Date: Apr. 6, 2023

(54) UNIVERSAL INTEGRATED CIRCUIT CARD (UICC) SERVICE

(71) Applicant: QUALCOMM Incorporated, San Diego, CA (US)

(72) Inventors: Jingnan QU, Beijing (CN); Jian LI, Shanghai (CN); Meng LIU, Beijing (CN); Yun PENG, Shenzhen (CN); Wei HE, Shanghai (CN); Hao ZHANG, Shanghai (CN); Xiaomin DONG, Shanghai (CN); Fojian ZHANG, Shenzhen (CN); Shouqiao ZHU, Xian (CN)

(21) Appl. No.: 17/798,292

(22) PCT Filed: Nov. 11, 2020
(86) PCT No.: PCT/CN2020/128053

§ 371 Date: Aug. 8, 2022

(30) Foreign Application Priority Data
Apr. 7, 2020 (WO) PCT/CN2020/083483

(51) Int. Cl. H04W 8/18; H04W 12/06; H04W 12/71

(52) U.S. Cl. CPC H04W 8/183; H04W 12/06; H04W 12/71

(57) ABSTRACT

A method to maintain network service for a mobile equipment includes reading a current integrated circuit card identification (ICCID) value when the mobile equipment supports a hot swap function and a remove interrupt is not triggered by hardware in response to a polling error triggered by a universal integrated circuit card (UICC). The method also includes comparing the current ICCID value to a cached ICCID value captured during a UICC initialization. The method further includes maintaining a current state of the UICC when the current ICCID value matches the cached ICCID value.

### CROSS-REFERENCE TO RELATED APPLICATION

The present application claims the benefit of International Patent Application No. PCT/CN2020/083483, filed Apr. 7, 2020, and titled “UNIVERSAL INTEGRATED CIRCUIT CARD (UICC) SERVICE,” the disclosure of which is expressly incorporated by reference herein in its entirety.

### TECHNICAL FIELD

The present disclosure generally relates to methods and systems for accessing network services from a wireless device. More specifically, the present disclosure relates to maintaining network service for a problematic universal integrated circuit card (UICC) of a device.

### BACKGROUND

Some designs of mobile communications/wireless devices (e.g., smart phones, tablet computers, and laptop computers) include a single universal integrated circuit card (UICC), multiple universal integrated circuit cards, or multiple subscriber identity module (SIM) cards. The cards store user identity information for multiple subscriptions that enable users to access multiple separate mobile telephony networks. Some of the UICCs (e.g., embedded UICCs (eUICCs)) are capable of supporting remote provisioning of network subscription information. A UICC may be removable or implemented within memory of mobile communications devices.

The information stored in a UICC may enable mobile communications devices to communicate with a variety of different types of mobile telephony networks. Examples of mobile telephony networks include third generation (3G), fourth generation (4G), long term evolution (LTE), fifth generation (5G) new radio (NR), time division multiple access (TDMA), orthogonal frequency division multiple access (OFDMA), code division multiple access (CDMA), CDMA 2000, wideband CDMA (WCDMA), global system for mobile communications (GSM), single-carrier radio transmission technology (1xRTT), and universal mobile telecommunications systems (UMTS). Each subscription enabled by a UICC or SIM may utilize a particular radio access technology (RAT) to communicate with its respective network. Maintaining service after a successful registration procedure, however, may fail when a problematic UICC provides an unexpected response to a STATUS command.

### SUMMARY

A method to maintain network service for a mobile equipment is described. The method includes reading a current integrated circuit card identification (ICCID) value when the mobile equipment supports a hot swap function and a remove interrupt is not triggered by hardware in response to a polling error triggered by a universal integrated circuit card (UICC). The method also includes comparing the current ICCID value to a cached ICCID value captured during a UICC initialization. The method further includes maintaining a current state of the UICC when the current ICCID value matches the cached ICCID value.

An apparatus to maintain network service for a mobile equipment is described. The apparatus includes means for reading a current integrated circuit card identification (ICCID) value when the mobile equipment supports a hot swap function and a remove interrupt is not triggered by hardware in response to a polling error triggered by a universal integrated circuit card (UICC) of the mobile equipment. The apparatus also includes means for comparing the current ICCID value to a cached ICCID value captured during a UICC initialization. The apparatus further includes means for maintaining a current state of the UICC when the current ICCID value matches the cached ICCID value.

An apparatus to maintain network service for a mobile equipment is described. The apparatus includes a memory, a universal integrated circuit card (UICC), and a communication interface coupled to the UICC of the mobile equipment. The apparatus also includes at least one processor coupled to the memory and the communication interface of the UICC. The processor(s) is configured to read a current integrated circuit card identification (ICCID) value when the mobile equipment supports a hot swap function and a remove interrupt is not triggered by hardware in response to a polling error triggered by the UICC. The processor(s) is also configured to compare the current ICCID value to a cached ICCID value captured during a UICC initialization. The processor(s) is further configured to maintain a current state of the UICC when the current ICCID value matches the cached ICCID value.

This has outlined, rather broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 shows a wireless device communicating with a wireless communications system.

FIG. 2 shows a block diagram of the wireless device in FIG. 1, according to an aspect of the present disclosure.

FIG. 3 is a process flow diagram of a method for maintaining service after a successful registration procedure when a problematic universal integrated circuit card (UICC) provides an unexpected response to a STATUS command, according to aspects of the present disclosure.

FIG. 4 depicts a simplified flowchart of a method to maintain network service for a problematic universal integrated circuit card (UICC) of a mobile equipment, according to aspects of the present disclosure.

FIG. 5 is a component block diagram of a wireless device suitable for implementing the method to maintain network service for a problematic universal integrated circuit card (UICC) of a mobile equipment, according to aspects of the present disclosure.

FIG. 6 is a block diagram showing an exemplary wireless communications system in which a configuration of the disclosure may be advantageously employed.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts. As described, the use of the term “and/or” is intended to represent an “inclusive OR,” and the use of the term “or” is intended to represent an “exclusive OR.”

The terms “subscriber identification module,” “SIM,” “universal subscriber identity module,” “USIM,” “user identity module,” “UIM,” “removable user identity module,” and “RUIM” are used to mean a memory that may be an integrated circuit or embedded into a removable card, which stores an international mobile subscriber identity (IMSI), related key, and/or other information used to identify and/or authenticate a wireless device on a network. In some networks (e.g., GSM networks), SIMs may store network specific information used to authenticate and identify subscribers on the network, the most important of which are the integrated circuit card identifier (ICCID), international mobile subscriber identity (IMSI), authentication key (Ki), and local area identity (LAI). The SIM may also store other carrier specific data, such as short message service center (SMSC) numbers, service provider names (SPNs), service dialing numbers (SDNs), and value added service (VAS) applications. In various aspects, a USIM and an RUIM may be modules in UMTS and CDMA networks, respectively, which provide equivalent functions to a SIM in a GSM network. However, the terms “SIM,” “USIM,” and “RUIM” may be used interchangeably to refer to a general module that is not restricted to a particular standard or technology.

The term “SIM” may also be used as a shorthand reference to a communications network associated with a particular SIM, because the information stored in a SIM enables the wireless device to establish a communications link with a particular network. Thus, the SIM and the communications network, as well as the services and subscriptions supported by that network, correlate to one another.

The terms “universal integrated circuit card,” “UICC,” “smart card,” and “SIM card,” are used interchangeably to refer to a memory chip or integrated circuit used to provide a SIM, a USIM, and/or an RUIM, to a wireless device (e.g., a mobile equipment) in order to store the described provisioning and/or other data. Various UICCs may have storage capabilities ranging from two to three kilobytes up to one gigabyte of information.

During an initialization phase of a UICC, a mobile equipment initiates registration with a network for the UICC. For example, a processor (e.g., a baseband processor) of the mobile equipment may provide passwords based on an initial selected application identifier (AID) command. Applications residing on the UICC are executed by an external reader, such as a baseband processor, by first selecting an application according to an AID, and then sending commands to the selected application (e.g., a USIM application). This initialization phase to activate the application is part of a network registration procedure. After completing this initialization phase to activate the selected application, an authentication procedure is performed as part of a network registration procedure.

The authentication procedure is initiated by the network, which transfers an authentication request message to the mobile equipment including the UICC. Once the mobile equipment successfully completes the authentication procedure, registration of the UICC with the network is complete. Accordingly, once successful authentication is completed, the mobile equipment registers a network for the UICC. Unfortunately, some problematic UICCs may cause their mobile equipment to incur a service failure. In particular, these problematic UICCs may cause a mobile originated (MO)/mobile terminated (MT) call failure even after successful registration. Consequently, the mobile equipment unexpectedly loses service.

These unsuccessful scenarios are generally caused by polling error. That is, when the UICC triggers a polling error, the mobile equipment is unable to perform an automatic recovery. For example, a process for triggering a polling error based on the current designs begins with expiration of a poll timer. Once a poll timer expires, the mobile equipment send a STATUS command to the UICC. In this example, a UICC response to this STATUS command includes response data, such as a dedicated file (DF). The dedicated file DF indicated in the response data should match the dedicated file DF indicated in previous response data (e.g., during initialization). When a mismatch is detected, the mobile equipment detects a polling error and reports a UICC error as the cause. The polling error eventually causes the mobile equipment to unexpectedly lose service.

The mobile equipment may support a hot swap function to switch the UICC within the mobile equipment. The dedicated file DF indicated in the response to the STATUS command should match the dedicated file DF indicated in previous response data (e.g., during initialization of the UICC). When a mismatch is detected, the mobile equipment reports a UICC error along with the polling error. That is, although the mobile equipment supports the hot swap function, regardless of whether the hot swap function is triggered, the mobile equipment loses service.

A problematic UICC, however, triggers this polling error even though the UICC is not removed or physically changed. That is, a remove interrupt is not triggered by hardware in response to the polling error triggered by the UICC. The mismatched dedicated files in the response data may be due to an internal software issue of the UICC. Aspects of the present disclosure are directed to a method for maintaining service after a successful registration procedure when a problematic UICC provides an unexpected response to a STATUS command from the mobile equipment. Aspects of the present disclosure are directed to avoiding lost service with a procedure performed by the mobile equipment as follows.

In aspects of the present disclosure, a problematic UICC is prevented from losing network service by reading an integrated circuit card identification (ICCID) value when the mobile equipment supports a hot swap function and a remove interrupt is not triggered by hardware in response to the polling error triggered by the UICC. When the mobile equipment supports the hot swap function and a remove interrupt is not triggered by hardware, the mobile equipment performs a verification process in response to a detected polling error of the UICC. The method includes comparing a read ICCID value to a cached ICCID value captured during UICC initialization. Because the UICC has completed initialization, a cache of the mobile equipment includes the cached ICCID value. The method further includes maintaining a state of the UICC when the read ICCID value matches the cached ICCID value. Maintaining the state of the UICC disregards the polling error and enables the mobile equipment to maintain network service for the UICC. Otherwise, the mobile equipment reports a UICC error with the polling error, resulting in lost service. This procedure is omitted by the mobile equipment when the mobile equipment does not support the hot swap function.

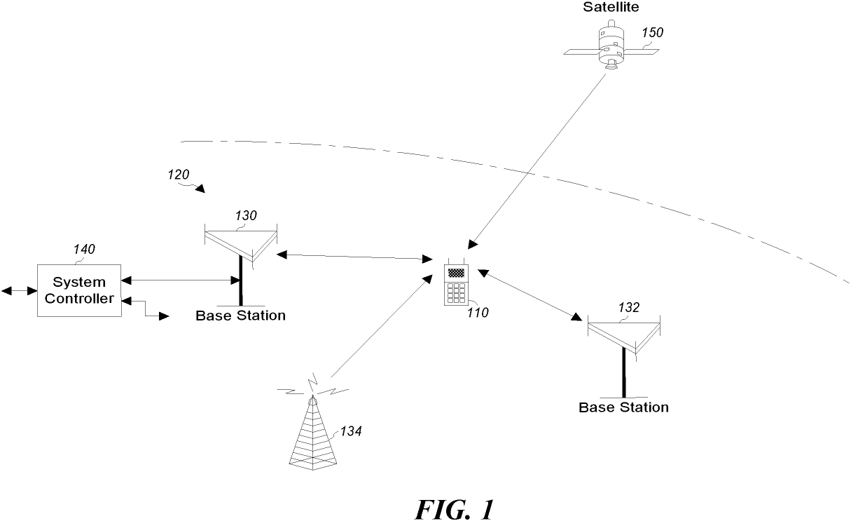

FIG. 1 shows a wireless device 110 that includes the disclosed universal integrated circuit card to maintain network service. The wireless device 110 communicates with a wireless communications system 120. The wireless device 110 includes a multi-band (e.g., dual-band) concurrent millimeter wave (mmW) transceiver. The wireless communications system 120 may be a 5G NR system, a long term evolution (LTE) system, a code division multiple access (CDMA) system, a global system for mobile communications (GSM) system, a wireless local area network (WLAN) system, millimeter wave (mmW) technology, or some other wireless system. A CDMA system may implement wideband CDMA (WCDMA), time division synchronous CDMA (TD-SCDMA), CDMA2000, or some other version of CDMA. In a millimeter wave (mmW) system, multiple antennas are used for beamforming (e.g., in the range of 30 GHz, 60 GHz, etc.). For simplicity, FIG. 1 shows the wireless communications system 120 including two base stations 130 and 132 and one system controller 140. In general, a wireless system may include any number of base stations and any number of network entities.

The wireless device 110 may be referred to as a mobile equipment, a user equipment (UE), a mobile station, a terminal, an access terminal, a subscriber unit, a station, etc. The wireless device 110 may also be a cellular phone, a smartphone, a tablet, a wireless modem, a personal digital assistant (PDA), a handheld device, a laptop computer, a Smartbook, a netbook, a cordless phone, a wireless local loop (WLL) station, a Bluetooth® device, etc. The wireless device 110 may be capable of communicating with the wireless communications system 120. The wireless device 110 may also be capable of receiving signals from broadcast stations (e.g., a broadcast station 134), signals from satellites (e.g., a satellite 150) in one or more global navigation satellite systems (GNSS), etc. The wireless device 110 may support one or more radio technologies for wireless communications such as 5G NR, LTE, CDMA2000, WCDMA, TD-SCDMA, GSM, 802.11, etc.

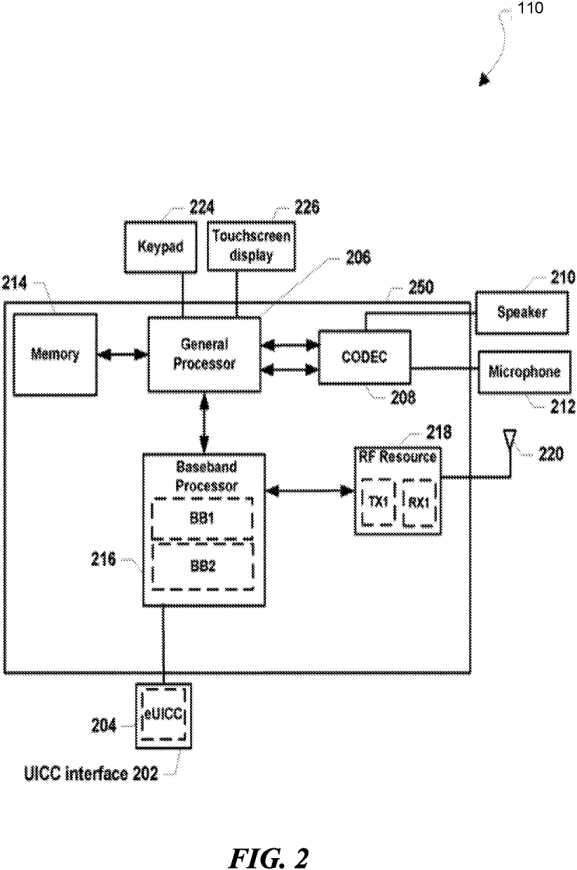

FIG. 2 shows a block diagram of the wireless device 110 in FIG. 1, according to an aspect of the present disclosure. The wireless device 110 may include a universal integrated circuit card (UICC) interface 202, which may receive an embedded UICC (eUICC) 204 that stores profiles associated with one or more subscriptions from network providers.

A UICC used in various examples may include user account information, an international mobile subscriber identity (IMSI), a set of SIM application toolkit (SAT) commands, and storage space for phone book contacts. The UICC may further store home identifiers (e.g., a system identification number (SID)/network identification number (NID) pair, a home preferred list of mobile networks (HPLMN) code, etc.) to indicate the network operator providers for each subscription of the UICC. An integrated circuit card identity (ICCID) SIM serial number may be printed on the UICC for identification. In some aspects, the UICC may be implemented within a portion of memory of the wireless device 110 (e.g., in a memory 214), and thus need not be a separate or removable circuit, chip, or card.

The wireless device 110 may include at least one controller, such as a general processor 206, which may be coupled to a coder/decoder (CODEC) 208. The CODEC 208 may in turn be coupled to a speaker 210 and a microphone 212. The general processor 206 may also be coupled to the memory 214. The memory 214 may be a non-transitory computer-readable storage medium that stores processor-executable instructions. The memory 214 may store an operating system (OS), as well as user application software and executable instructions. The memory 214 may also store locally cached profiles for subscriptions supported by the eUICC 204.

The general processor 206 and the memory 214 may each be coupled to at least one baseband processor or baseband modem processor 216. The eUICC 204 in the wireless device 110 may utilize one or more baseband-radio frequency (RF) resource. A baseband-RF resource may include the baseband modem processor 216, which may perform baseband/modem functions for communications with and controlling of a radio access technology (RAT). The baseband-RF resource may include one or more amplifiers and radios, referred to generally as radio frequency (RF) resources (e.g., RF resource 218). In some examples, the baseband-RF resources may share the baseband modem processor 216 (e.g., a single device that performs baseband/modem functions for all RATs on the wireless device 110). In other examples, each baseband-RF resource may include physically or logically separate baseband processors (e.g., BB1, BB2).

The RF resource 218 may be a transceiver that performs transmit/receive functions for the eUICC 204 on the wireless device 110. The RF resource 218 may include separate transmit and receive circuitry, or may include a transceiver that combines transmitter and receiver functions. In some examples, the RF resource 218 may include multiple receive circuits. The RF resource 218 may be coupled to a wireless antenna (e.g., a wireless antenna 220). The RF resource 218 may also be coupled to the baseband modem processor 216.

In some examples, the general processor 206, the memory 214, the baseband modem processor(s) 216, and the RF resource 218 may be included in the wireless device 110 as a system-on-chip 250. In some examples, the eUICC 204 and its corresponding UICC interface 202 may be external to the system-on-chip 250. Further, various input and output devices may be coupled to components on the system-on-chip 250, such as interfaces or controllers. Example user input components suitable for use in the wireless device 110 may include, but are not limited to, a keypad 224, a touchscreen display 226, and the microphone 212.

In some examples, the keypad 224, the touchscreen display 226, the microphone 212, or a combination thereof, may perform the function of receiving a request to initiate an outgoing call or receiving a personal identification number. Interfaces may be provided between the various devices and modules to implement functions in the wireless device 110 to enable communications in the wireless device.

Functioning together, the eUICC 204, the baseband processor BB1, BB2, the RF resource 218, and the wireless antenna 220 may constitute two or more radio access technologies (RATs). For example, the wireless device 110 may be a communications device that includes a UICC, baseband processor, and RF resource configured to support two different RATs, such as NR or LTE and GSM. More RATs may be supported on the wireless device 110 by adding more RF resources, and antennae for connecting to additional mobile networks.

In some examples (not shown), the wireless device 110 may include, among other things, additional UICC or SIM cards, UICC or SIM interfaces, multiple RF resources associated with the additional UICC or SIM cards, and additional antennae for supporting subscription communications with additional mobile networks.

The eUICC 204 may support multiple mobile network operator profiles, or subscription profiles. For example, a user may download multiple profiles onto the eUICC 204. Each profile may store static SIM information to support a subscription with one or more mobile telephony networks. Thus, the eUICC 204 may play the role of multiple SIMs, because each SIM supports one profile.

In various examples, the wireless device 110 may be configured to locally cache one or more subscription profiles associated with or stored in the UICC. The profiles may be cached in the memory 214, part of which may be designated memory for the modem.

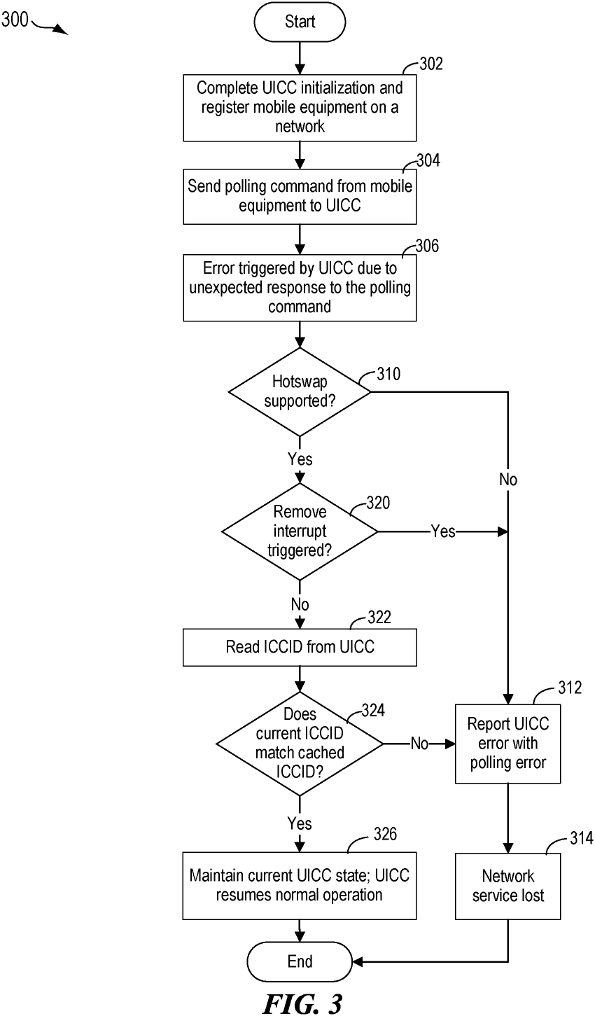

FIG. 3 is a process flow diagram of a method 300 to maintain network service for a problematic universal integrated circuit card (UICC) of a mobile equipment, according to aspects of the present disclosure. At block 302, the UICC of the mobile equipment powers up and initialization of the UICC is completed to register the mobile equipment (ME) with a network. At block 304, the mobile equipment sends a polling command to the UICC when the UICC card is in an idle state. At block 306, the UICC sends an unexpected response to the polling command to trigger a polling error. In blocks 302-306, a processor (e.g., a baseband processor) of the mobile equipment communicates through a UICC interface to perform initialization and registration of the UICC.

For example, the issuance of a polling command begins with expiration of a poll timer. Once the poll timer expires, the mobile equipment sends a STATUS command to the UICC. In this example, the UICC response to this STATUS command includes response data, such as a dedicated file (DF). The dedicated file DF indicated in the response data should match a dedicated file DF indicated in previous response data. When a mismatch is detected, the mobile equipment reports a polling error due to the UICC error, causing the mobile equipment to unexpectedly lose service. Aspects of the present disclosure are directed to a method for maintaining service after a successful registration procedure when a problematic UICC provides an unexpected response to a STATUS command from the mobile equipment.

At block 310, it is determined whether the mobile equipment supports a hot swap function. When the mobile equipment supports the hot swap function (at block 310), control flow branches to block 320, in which it is determined whether a remove interrupt is triggered by hardware in response to the polling error triggered by the UICC. When the remove interrupt is not triggered by hardware in response to the polling error triggered by the UICC, control flow branches to block 322, in which the mobile equipment performs a verification process in response to a detected polling error of the UICC at blocks 322 to 326. Otherwise, control flow proceeds to block 312, in which the mobile equipment reports the polling error due to the UICC error, and at block 314, the mobile equipment loses network service.

At block 322, the verification method begins by reading an integrated circuit card identification (ICCID) value from the SIM card. At block 324, the current ICCID value is compared to a cached ICCID value captured during SIM card initialization. Because the UICC has completed initialization, a cache of the mobile equipment includes the cached ICCID value. The method further includes maintaining a state of the UICC, at block 326, when the read ICCID value matches the cached ICCID value. Maintaining the state of the UICC disregards the polling error to maintain network service for the UICC. Otherwise, at blocks 312 and 314, the mobile equipment reports a subscriber identity module (SIM) error with the polling error, resulting in lost service. This verification procedure is omitted by the mobile equipment when the mobile equipment does not support the hot swap function.

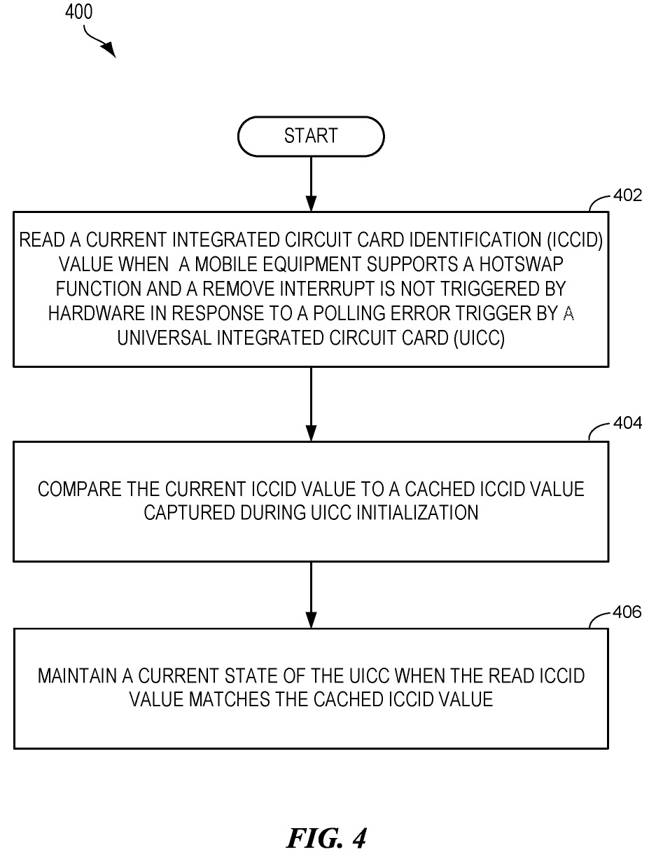

FIG. 4 depicts a simplified flowchart of a method 400 to maintain network service for a problematic universal integrated circuit card (UICC) of a mobile equipment, according to aspects of the present disclosure. At block 402, a processor (e.g., a baseband processor) of the mobile equipment reads a current integrated circuit card identification (ICCID) value when the mobile equipment supports a hot swap function and a remove interrupt is not triggered by hardware in response to a polling error triggered by the UICC. For example, as shown at block 322 of FIG. 3, the baseband processor reads a current ICCID from a SIM card. At block 404, the processor compares the current ICCID value to a cached ICCID value captured during a UICC initialization. For example, as shown at block 324 of FIG. 3, the current and cached ICCID values are compared.

At block 406, the processor maintains a current state of the UICC when the current ICCID value matches the cached ICCID value. For example, as shown at block 326 of FIG. 3, the mobile equipment maintains a state (e.g., a network state) of the UICC when the current ICCID value matches the cached ICCID value. Maintaining the current state of the UICC disregards the polling error to maintain network service for the UICC. The method 400 may also include reporting a UICC error as a cause for the polling error when the current ICCID value mismatches the cached ICCID value.

According to a further aspect of the present disclosure, an apparatus to maintain network service for a problematic UICC of a mobile equipment supporting hot swap functionality is described. The apparatus may include means for reading a current integrated circuit card identification (ICCID) value when the mobile equipment supports a hot swap function in response to a polling error triggered by the UICC; means for comparing the current ICCID value to a cached ICCID value captured during a UICC initialization; and means for maintaining a current state of the UICC when the current ICCID value matches the cached ICCID value. The apparatus also includes means for completing, means for disregarding, means for registering, means for reporting, and/or means for resuming normal operation of the UICC. The reading means, the comparing means, the completing means, the disregarding means, the registering means, the reporting means, the resuming normal operation means and/or the maintaining means may be the baseband modem processor 216, the general processor 206, and/or the memory 214. In another aspect of the present disclosure, the aforementioned means may be any module or apparatus configured to perform the functions recited by the aforementioned means. (To be completed after claim language approval.)

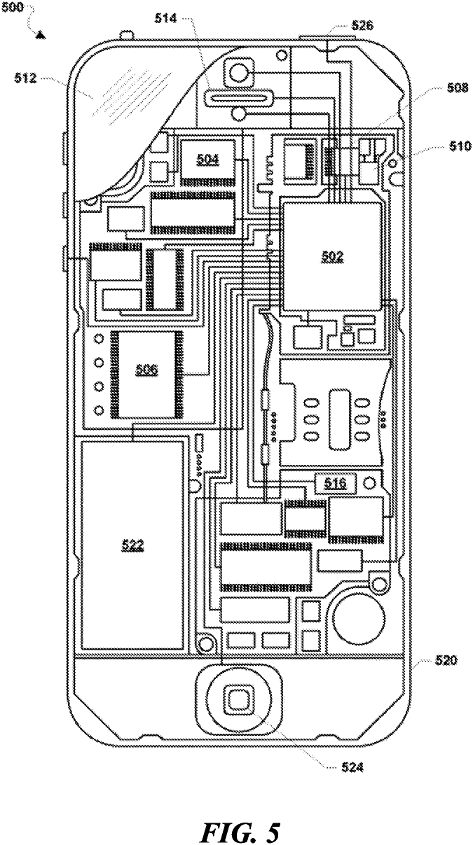

FIG. 5 is a component block diagram of a wireless device 500 suitable for implementing the method to maintain network service for a problematic universal integrated circuit card (UICC). Aspects of the present disclosure may be implemented in any of a variety of wireless devices, an example of which (e.g., wireless device 500) is illustrated in FIG. 5. The wireless device 500 may be similar to the wireless device 110 and may implement the method 300 and the method 400.

The wireless device 500 may include a processor 502 coupled to a touchscreen controller 504 and an internal memory 506. The processor 502 may be one or more multi-core integrated circuits designated for general or specific processing tasks. The internal memory 506 may be volatile or non-volatile memory, and may also be secure and/or encrypted memory, or unsecured and/or unencrypted memory, or any combination thereof. The touchscreen controller 504 and the processor 502 may also be coupled to a touchscreen panel 512, such as a resistive-sensing touchscreen, capacitive-sensing touchscreen, infrared sensing touchscreen, etc. Additionally, the display of the wireless device 500 need not have touch screen capability.

The wireless device 500 may have one or more cellular network transceivers 508 coupled to the processor 502 and to one or more antennas 510 and configured for sending and receiving cellular communications. The one or more cellular network transceivers 508 and the one or more antennas 510 may be used with the above-mentioned circuitry to implement the various example methods described. The wireless device 500 may include one or more UICC or SIM cards 516, coupled to the one or more cellular network transceivers 508 and/or the processor 502, and may be configured as described above.

The wireless device 500 may also include speakers 514 for providing audio outputs. The wireless device 500 may also include a housing 520, constructed of plastic, metal, or a combination of materials, for containing all or some of the components discussed. The wireless device 500 may include a power source 522 coupled to the processor 502, such as a disposable or rechargeable battery. The rechargeable battery may also be coupled to the peripheral device connection port to receive a charging current from a source external to the wireless device 500. The wireless device 500 may also include a physical button 524 for receiving user inputs. The wireless device 500 may also include a power button 526 for turning the wireless device 500 on and off.

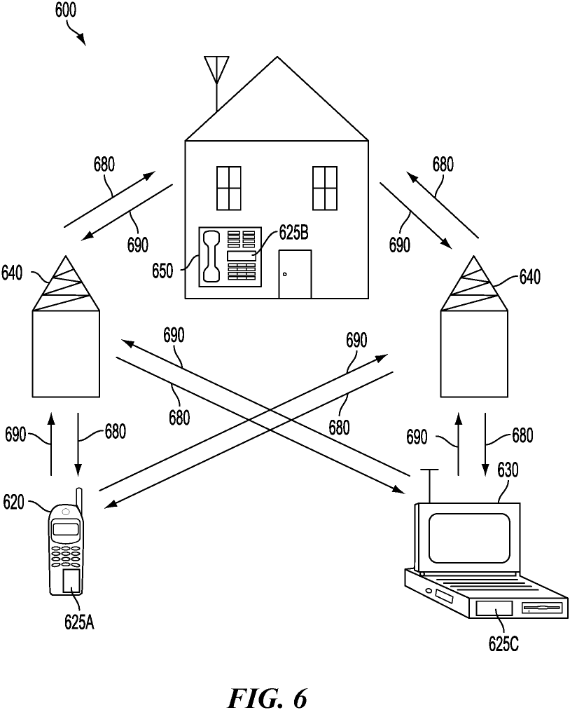

FIG. 6 is a block diagram showing an exemplary wireless communications system in which a configuration of the disclosure may be advantageously employed. For purposes of illustration, FIG. 6 shows three remote units 620, 630, and 650, and two base stations 640. It will be recognized that wireless communications systems may have many more remote units and base stations. Remote units 620, 630, and 650 include IC devices 625A, 625B, and 625C that include the disclosed wireless device including the subsystem or universal integrated circuit card. It will be recognized that other devices may also include the disclosed wireless device, such as the base stations, switching devices, and network equipment. FIG. 6 shows forward link signals 680 from the base stations 640 to the remote units 620, 630, and 650, and reverse link signals 690 from the remote units 620, 630, and 650 to base stations 640.

In FIG. 6, remote unit 620 is shown as a mobile telephone, remote unit 630 is shown as a portable computer, and remote unit 650 is shown as a fixed location remote unit in a wireless local loop system. For example, a remote unit may be a mobile phone, a hand-held personal communications systems (PCS) unit, a portable data unit such as a personal digital assistant (PDA), a GPS enabled device, a navigation device, a set top box, a music player, a video player, an entertainment unit, a fixed location data unit such as meter reading equipment, or other communications device that stores or retrieves data or computer instructions, or combinations thereof. Although FIG. 6 illustrates remote units according to the aspects of the present disclosure, the disclosure is not limited to these exemplary illustrated units. Aspects of the disclosure may be suitably employed in many devices, which include the wireless device including the universal integrated circuit card.

In some aspects, techniques for maintaining network service for a mobile equipment may include additional aspects, such as any single aspect or any combination of aspects described below or in connection with one or more other processes or devices described elsewhere herein. In a first aspect, techniques for maintaining network service for the mobile equipment includes reading a current integrated circuit card identification (ICCID) value when the mobile equipment supports a hot swap function and a remove interrupt is not triggered by hardware in response to a polling error triggered by a universal integrated circuit card (UICC). The techniques also include comparing the current ICCID value to a cached ICCID value captured during a UICC initialization. The techniques further include maintaining a current state of the UICC when the current ICCID value matches the cached ICCID value. In some examples, the techniques in the first aspect may be implemented in a method, process, or means. In some other examples, the techniques of the first aspect may be implemented in a wireless communication device such as a UE or a component of a UE. In some examples, the wireless communication device may include at least one processing unit or system (which may include an application processor, a modem or other components) and at least one memory device coupled to the processing unit. The processing unit may be configured to perform operations described with respect to the wireless communication device.

In a second aspect, alone or in combination with the first aspect, the techniques include reporting a subscriber identity module (SIM) error as a cause for the polling error when the mobile equipment does not support the hot swap function.

In a third aspect, alone or in combination with the first aspect, the techniques include reporting a UICC error as a cause for the polling error when the current ICCID value mismatches the cached ICCID value.

In a fourth aspect, alone or in combination with the first aspect or the third aspect, the techniques include the UICC error comprising a subscriber identity module (SIM) error.

In a fifth aspect, alone or in combination with any of the first to the fourth aspect, in which the techniques for maintaining the current state of the UICC comprise disregarding the polling error to maintain the network service for the UICC.

In a sixth aspect, alone or in combination with any of the first to the fifth aspect, the techniques include completing an authentication procedure by the UICC; and registering the UICC with a network from which the authentication procedure is initiated to the mobile equipment.

In a seventh aspect, alone or in combination with any of the first to the sixth aspect, the techniques include resuming normal operation of the UICC to provide the network service to the mobile equipment.

For a firmware and/or software implementation, the methodologies may be implemented with modules (e.g., procedures, functions, and so on) that perform the functions described. A machine-readable medium tangibly embodying instructions may be used in implementing the methodologies described. For example, software codes may be stored in a memory and executed by a processor unit. Memory may be implemented within the processor unit or external to the processor unit. As used, the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer. Disk and disc, as used, include compact disc (CD), laser disc, optical disc, digital versatile disc (DVD), floppy disk and Blu-ray® disc, where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communications apparatus. For example, a communications apparatus may include a standard cell circuit having signals indicative of instructions and data. The instructions and data are configured to cause one or more processors to implement the functions outlined in the claims.

The various illustrative logical blocks, modules, and circuits described in connection with the disclosure may be implemented or performed with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

Although the present disclosure and its advantages have been described in detail, it should be understood that various changes, substitutions, and alterations can be made without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present application is not intended to be limited to the particular configurations of the process, machine, manufacture, and composition of matter, means, methods, and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described may be utilized according to the present disclosure. Accordingly, the appended claims are intended to include within their scope such processes, machines, manufacture, compositions of matter, means, methods, or steps.

What is claimed is:

1. A method to maintain network service for a mobile equipment, comprising:
reading a current integrated circuit card identification (ICCID) value when the mobile equipment supports a hot swap function and a remove interrupt is not triggered by hardware in response to a polling error triggered by a universal integrated circuit card (UICC) of the mobile equipment;
comparing the current ICCID value to a cached ICCID value captured during a UICC initialization; and
maintaining a current state of the UICC when the current ICCID value matches the cached ICCID value.

2. The method of claim 1, further comprising:
reporting a subscriber identity module (SIM) error as a cause for the polling error when the mobile equipment does not support the hot swap function.

3. The method of claim 1, further comprising:
reporting a UICC error as a cause for the polling error when the current ICCID value mismatches the cached ICCID value.

4. The method of claim 3, in which the UICC error comprises a subscriber identity module (SIM) error.

5. The method of claim 1, in which maintaining the current state of the UICC comprises disregarding the polling error to maintain the network service for the UICC.

6. The method of claim 1, further comprising:
completing an authentication procedure by the UICC; and
registering the UICC with a network from which the authentication procedure is initiated to the mobile equipment.

7. The method of claim 1, further comprising resuming normal operation of the UICC to provide the network service to the mobile equipment.

8. An apparatus to maintain network service for a mobile equipment, comprising:
means for reading a current integrated circuit card identification (ICCID) value when the mobile equipment supports a hot swap function and a remove interrupt is not triggered by hardware in response to a polling error triggered by a universal integrated circuit card (UICC) of the mobile equipment;
means for comparing the current ICCID value to a cached ICCID value captured during a UICC initialization; and
means for maintaining a current state of the UICC when the current ICCID value matches the cached ICCID value.

9. The apparatus of claim 8, further comprising
means for reporting a subscriber identity module (SIM) error as a cause for the polling error when the mobile equipment does not support the hot swap function.

10. The apparatus of claim 8, further comprising:
means for reporting a UICC error as a cause for the polling error when the current ICCID value mismatches the cached ICCID value.

11. The apparatus of claim 10, in which the UICC error comprises a subscriber identity module (SIM) error.

12. The apparatus of claim 8, in which the means for maintaining the current state of the UICC comprises means for disregarding the polling error to maintain the network service for the UICC.

13. The apparatus of claim 8, further comprising:
means for completing an authentication procedure by the UICC; and
means for registering the UICC with a network from which the authentication procedure is initiated to the mobile equipment.

14. The apparatus of claim 8, further comprising means for resuming normal operation of the UICC to provide the network service to the mobile equipment.

15. An apparatus to maintain network service for a mobile equipment, comprising:
a memory;
a universal integrated circuit card (UICC);
a communication interface coupled to the UICC of the mobile equipment; and
at least one processor coupled to the memory and the communication interface of the UICC, the at least one processor configured:
to read a current integrated circuit card identification (ICCID) value when the mobile equipment supports a hot swap function and a remove interrupt is not triggered by hardware in response to a polling error triggered by the UICC;
to compare the current ICCID value to a cached ICCID value captured during a UICC initialization; and
to maintain a current state of the UICC when the current ICCID value matches the cached ICCID value.

16. The apparatus of claim 15, in which the at least one processor is further configured to report a subscriber identity module (SIM) error as a cause for the polling error when the mobile equipment does not support the hot swap function.

17. The apparatus of claim 15, in which the at least one processor is further configured to report a UICC error as a cause for the polling error when the current ICCID value mismatches the cached ICCID value.

18. The apparatus of claim 15, in which the at least one processor is configured to maintain the current state of the UICC by disregarding the polling error to maintain the network service for the UICC.

19. The apparatus of claim 15, in which the at least one processor is further configured:
to complete an authentication procedure by the UICC; and
to register the UICC with a network from which the authentication procedure is initiated to the mobile equipment.

20. The apparatus of claim 15, in which the at least one processor is further configured to resume normal operation of the UICC to provide the network service to the mobile equipment.
